(19) United States
(12) Patent Application Publication
(10) Pub. No.: US 2005/0105699 A1
(43) Pub. Date: May 19, 2005

(54) Communications terminal, voice spectrum information search server, individual information display system, individual information display method in communications terminal and individual information display program

(75) Inventor: Satoru Ueyama, Kato (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/022,673

(22) Filed: Dec. 28, 2004

Related U.S. Application Data
(63) Continuation of application No. PCT/JP02/10999, filed on Oct. 23, 2002.

(51) Int. Cl. H04M 1/64

(52) U.S. Cl. 379/88.19; 379/88.22

(57) ABSTRACT

A communications terminal that displays the individual information of the caller at the start of a communication caused by an incoming call, comprising: a FLASH-ROM 10 forming a database that stores individual information for registered individuals and voice spectrum information for the individuals, in a mutually associated manner; a voice spectrum analyzing section 6 that extracts the voice spectrum information of a caller from the voice of the caller at the start of a communication caused by an incoming call; an MPU 7 that identifies a caller from among individuals in a database by comparing the voice spectrum information of the caller with voice spectrum information in the database; and an LCD 17 forming a display section that displays the individual information of the identified caller.

### TECHNICAL FIELD

The present invention relates to a communications terminal and a voice spectrum information search server for identifying an individual by using the voice spectrum of a caller at the start of a call caused by an incoming call, and displaying that individual information on a screen, and to an individual information display method in the communications terminal and an individual information display program. The communications terminal may be a portable terminal, such as a portable telephone.

### BACKGROUND ART

Conventionally, in a call using a communications terminal, or the like, in order that the user of the communications terminal receiving the call can identify the user of the communications terminal originating the call (the caller), the user must either ask the name of the caller at the start of the call or judge the identity of the caller from the caller's voice. Furthermore, if a call is being made using a communications terminal having a function for displaying the telephone number or name of the calling party when an incoming call is received, then the user is able to ascertain the identity of the calling party by observing the displayed telephone number or name. As described in Japanese Patent Laid-open No. 2001-218267, for example, the name of the caller is displayed by receiving an electromagnetic wave transmitted by the portable telephone, at a transceiver, and then comparing the telephone number of the portable telephone contained in the electromagnetic wave with an individual authentication database, in an individual authentication judging section.

However, in conventional technology of this kind, even if a communications terminal which displays the telephone number or name of the calling party is used, in cases where the telephone number originating the call is used by a plurality of people, for example, in cases where the telephone number originating the call is the telephone number of a company or organization, then it is not possible to identify the individual person who is making the call. Furthermore, if the communications terminal originating the call is being used by someone other than the owner, then the calling party will be identified incorrectly as the owner of the communications terminal.

The present invention was devised in order to resolve problems of these kinds, an object thereof being to provide a communications terminal and a voice spectrum information search server for identifying an individual caller by using the voice spectrum of a caller at the start of a call caused by an incoming call, and displaying that individual information on a screen, and to an individual information display method in the communications terminal and an individual information display program.

### DISCLOSURE OF THE INVENTION

The communications terminal according to the present invention comprises: a database for storing individual information for a registered individual person, for example, and voice spectrum information for the individual, in an associated manner; a voice spectrum analyzing section for extracting voice spectrum information for the caller from the voice of the caller, at the start of a communication caused by an incoming call; a calculating section for identifying individual information in the database relating to the caller, by comparing the voice spectrum information for the caller with voice spectrum information in the database; and a display section for displaying individual information for the caller thus identified.

According to a composition of this kind, the user, for example, is able to observe the individual information displayed on a display section at the start of a communication caused by an incoming call, and hence the user is able to identify the caller. The display section may also indicate information by means of sound. Here, the database in the first embodiment is a FLASH-ROM 10, the voice spectrum analyzing section is the voice spectrum analyzing section 6, the calculating section is the MPU 7, and the display section is the LCD 17.

In the communications terminal relating to the present invention, for example, an input section whereby a user inputs individual information for the caller is provided; and if the voice spectrum information of the caller obtained by the voice spectrum analyzing section is not registered in the database, then a set consisting of the voice spectrum information of the caller and the individual information of the caller obtained via the input section is registered in the database.

According to the present embodiment, if the voice spectrum information of the caller is not stored in the database in the communications terminal, then the user is able to input individual information relating to the caller and to save the voice spectrum information and individual information in a mutually linked fashion, in the database in the communications terminal. The input section in the first embodiment is the keypad 18.

Furthermore, the present invention is a voice spectrum information search server capable of connecting to a communications terminal by means of a communications circuit, comprising: for example, a database for storing individual information for a registered individual person and voice spectrum information for the individual, in an associated manner; a reception section for receiving information including voice spectrum information from the communications terminal; a calculating section for identifying individual information (a person having the received voice spectrum information) in the database, by comparing voice spectrum information received by the reception section with voice spectrum information in the database; and a transmission section for transmitting the individual information in the database thus identified, to the communications terminal.

Furthermore, the present invention is a communications terminal capable of connecting to the voice spectrum information search server by means of a communications circuit, comprising: a voice spectrum analyzing section for extracting voice spectrum information for the caller from the voice of the caller, at the start of a communication caused by an incoming call; a transmission section for transmitting voice spectrum information for the caller to the voice spectrum information search server; a reception section for receiving individual information for the caller from the voice spectrum information search server; and a display section for displaying the individual information for the caller obtained by the reception section.

According to a composition of this kind, the user is able to observe the individual information displayed on a display section at the start of a communication caused by an incoming call, and hence the user is able to identify the caller. Moreover, since a single database is provided in the voice spectrum information search server and it is therefore unnecessary to provide individual databases in each communications terminal, then the size of the circuitry in the communications terminal can be reduced. In the second embodiment, the voice spectrum information search server is the server 40, the communications terminal is the communications terminal 1A, the database is the storage section 44, the transmission section and the reception section are the signal processing section 41, the calculating section is the control section 43, the voice spectrum analyzing section is the voice spectrum analyzing section 6, the transmission section and reception section are the signal processing section 3, and the display section is the LCD 17.

In the communications terminal relating to the present invention, an input section for inputting individual information for the caller is provided; and if, for example, individual information for the caller is not received from the voice spectrum information search server, then a set consisting of the voice spectrum information of the caller and the individual information of the caller obtained via the input section is registered in the database of the voice spectrum information search server.

According to the present embodiment, if the voice spectrum information of the caller is not stored in the database in the voice spectrum information search server, then the user is able to input individual information via the input section and to save the voice spectrum information and individual information for the caller in a mutually linked fashion, in the database of the voice spectrum information search server. In the second embodiment, the input section is the keypad 18. Furthermore, according to the present invention, the individual information display system is constituted by this voice spectrum information search server and communications terminal.

Furthermore, the present invention is a voice spectrum information search server capable of connecting to a communications terminal by means of a communications circuit, comprising: for example, a database for storing individual information for a registered individual person, for example, and voice spectrum information for the individual, in an associated manner; a reception section for receiving information including a voice from a communications terminal; a voice spectrum analyzing section for extracting voice spectrum information from the voice received by the reception section; a calculating section for identifying individual information in the database, by comparing voice spectrum information extracted by the voice spectrum analyzing section with voice spectrum information in the database; and a transmission section for transmitting the individual information in the database thus identified, to the communications terminal.

Furthermore, the present invention is a communications terminal capable of connecting to the voice spectrum information search server by means of a communications circuit, comprising: a transmission section for transferring the voice of a caller to the voice spectrum information search server, at the start of a communication caused by an incoming call; a reception section for receiving individual information for the caller from the voice spectrum information search server; and a display section for displaying the individual information for the caller obtained by the reception section.

According to a composition of this kind, the user is able to observe the individual information displayed on a display section at the start of a communication caused by an incoming call, and hence the user is able to identify the caller. Furthermore, by carrying out voice spectrum analysis and comparison in a voice spectrum information search server having a higher computing capacity than the communications terminal, it is possible to identify an individual person rapidly, and furthermore, since it is unnecessary to provide a voice spectrum analyzing section and a database individually in the communications terminal, then the size of the circuitry in the communications terminal can be reduced. In the third embodiment, the voice spectrum information search server is the server 60, the communications terminal is the communications terminal 50, the database is the storage section 65, the voice spectrum analyzing section is the voice spectrum analyzing section 64, the transmission section and the reception section are the signal processing section 61, the calculating section is the control section 63, the transmission section and reception section are the signal processing section 3, and the display section is the LCD 17.

In the communications terminal relating to the present invention, an input section for inputting individual information for the caller is provided; and if individual information for the caller, for example, is not received from the voice spectrum information search server, then a set consisting of the voice spectrum information of the caller and the individual information of the caller obtained via the input section is registered in the database of the voice spectrum information search server.

According to the present embodiment, if the voice spectrum information of the caller is not stored in the database in the voice spectrum information search server, then the user is able to input individual information via the input section and to save the voice spectrum information and individual information for the caller in a mutually linked fashion, in the database of the voice spectrum information search server. In the third embodiment, the input section is the keypad 18. Furthermore, according to the present invention, the individual information display system is constituted by this voice spectrum information search server and communications terminal.

Furthermore, the present invention is an individual information display method in a communications terminal for displaying individual information for a caller at the start of a communication caused by an incoming call, comprising the steps of: for example, storing individual information for a registered individual person and voice spectrum information for the individual, in an associated manner, in a database; extracting voice spectrum information for the caller from the voice of the caller; identifying individual information in the database relating to the caller, by comparing the voice spectrum information for the caller with voice spectrum information in the database; and displaying individual information for the caller thus identified.

Furthermore, the present invention is an individual information display program stored on a computer-readable medium in order to cause a computer to execute display of individual information for a caller at the start of a communication caused by an incoming call, wherein the program causes a computer to execute the steps of: for example, storing individual information for a registered individual person and voice spectrum information for the individual, in an associated manner, in a database; extracting voice spectrum information for the caller from the voice of the caller; identifying individual information in the database relating to the caller, by comparing the voice spectrum information for the caller with voice spectrum information in the database; and displaying individual information for the caller thus identified. This program can be stored on a computer-readable storage medium, and the storage medium may be a semiconductor memory, such as a ROM, RAM, or the like, a portable storage medium, such as a CD-ROM, flexible disk, a DVD disk, magneto-optical disk, IC card, or the like, or a database storing a computer program, or the like.

### BRIEF DESCRIPTION OF THE DRAWINGS

FIG. 1 is a block diagram showing the composition of a communications terminal relating to a first embodiment of the present invention;

FIG. 2 is a flowchart showing one example of an operation for identifying a caller in a communications terminal relating to a first embodiment of the present invention;

FIG. 3 is a block diagram showing one example of the composition of a communications system comprising a communications terminal and a server;

FIG. 4 is a block diagram showing one example of the composition of a server relating to a second embodiment of the present invention;

FIG. 5 is a flowchart showing one example of an operation for identifying a caller in a communications terminal relating to a second embodiment of the present invention;

FIG. 6 is a flowchart showing one example of an operation for identifying a caller in a server relating to a second embodiment of the present invention;

FIG. 7 is a block diagram showing one example of the composition of a communications terminal relating to a third embodiment of the present invention;

FIG. 8 is a block diagram showing one example of the composition of a server relating to a third embodiment of the present invention;

FIG. 9 is a flowchart showing one example of an operation for identifying a caller in a communications terminal relating to a third embodiment of the present invention; and

FIG. 10 is a flowchart showing one example of an operation for identifying a caller in a server relating to a third embodiment of the present invention.

### BEST MODE FOR CARRYING OUT THE INVENTION

### Preferred Embodiments

Below, embodiments of the present invention are described in detail with reference to the drawings. In the embodiments of the present invention, a communications terminal performing radio communications is taken as an example of a communications terminal.

### First Embodiment

This embodiment is described with respect to a case where, upon receiving an incoming call at a communications terminal, the caller is identified by means of the communications terminal analyzing the voice spectrum, performing a search for voice spectrum information, and then displaying individual information.

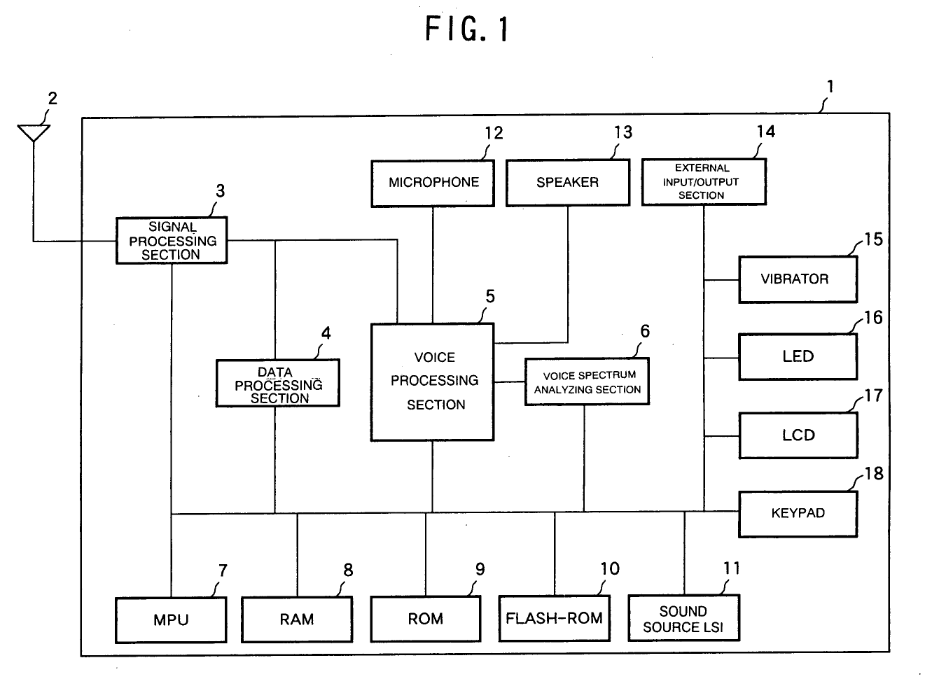

Firstly, the composition and operation of the communications terminal will be described. FIG. 1 is a block diagram showing the composition of a communications terminal relating to a first embodiment of the present invention. As shown in FIG. 1, the communications terminal 1 is constituted by a transmitting and receiving antenna 2, a signal processing section 3, a data processing section 4, a voice processing section 5, a voice spectrum analyzing section 6, a MPU (Microprocessing Unit) 7, a RAM (Random Access Memory) 8, a ROM (Read Only Memory) 9, a FLASH-ROM 10, a sound source LSI (Large Scale Integrated Circuit) 11, a microphone 12, a speaker 13, an external input/output section 14, a vibrator 15, an LED (Light Emitting Diode) 16, an LCD (Liquid Crystal Display) 17 and a keypad 18.

The MPU 7 is connected to the signal processing section 3, data processing section 4, voice processing section 5, voice spectrum analyzing section 6, RAM 8, ROM 9, FLASH-ROM 10, sound source LSI (Large Scale Integrated Circuit) 11, external input/output section 14, vibrator 15, LED (Light Emitting Diode) 16, LCD (Liquid Crystal Display) 17 and keypad 18, and it controls these respective elements.

In a transmission operation, the signal processing section 3 synthesizes non-voice data from the data processing section 4 and voice data from the voice processing section 5, and transmits it externally via the transmitting and receiving antenna 2. In a reception operation, if the signal received via the transmitting and receiving antenna 2 is non-voice data, namely, data other than a voice, then the signal processing section 3 outputs the signal to the data processing section 4, and if the signal is voice data, then it outputs the signal to the voice processing section 5.

The non-voice data is output as text, images, or the like, to the LCD 17, via the data processing section 4. The voice processing section 5 outputs voice data externally as a voice sound via the speaker 13, in addition to which it outputs the voice data required for analyzing the voice spectrum to the voice spectrum analyzing section 6. Furthermore, the voice processing section 5 outputs a voice received from an external source via the microphone 12, to the signal processing section 3, as voice data.

The voice spectrum analyzing section 6 performs a voice spectrum analysis with respect to the voice data received, by using a process as disclosed in Japanese patent publication No. 3280825, for example, and it calculates voice spectrum information consisting of a time distribution for each frequency, a voice emission time, a pitch frequency, and the like, and outputs same to the RAM 8.

The ROM 9 stores a program for the MPU 7, and the like. The RAM 8 stores the information required in order to execute the program of the MPU 7. Furthermore, the RAM 8 also temporarily stores the voice spectrum information.

The FLASH-ROM 10 stores a database which links voice spectrum information with individual information. Here, the individual information includes, for example, a name, age, gender, company name, telephone number, serial number, and the like.

The sound source LSI 11 generates an incoming call tone, or the like.

The external input/output section 14 inputs and outputs data from and to an external PC, or the like, by means of a cable, or the like. The vibrator 15 generates a vibration in the case of an incoming call, or the like. The LED 16 generates light in the case of an incoming call, or the like. The LCD 17 displays text or images. The keypad 18 is used to input individual information, and the like, by the user.

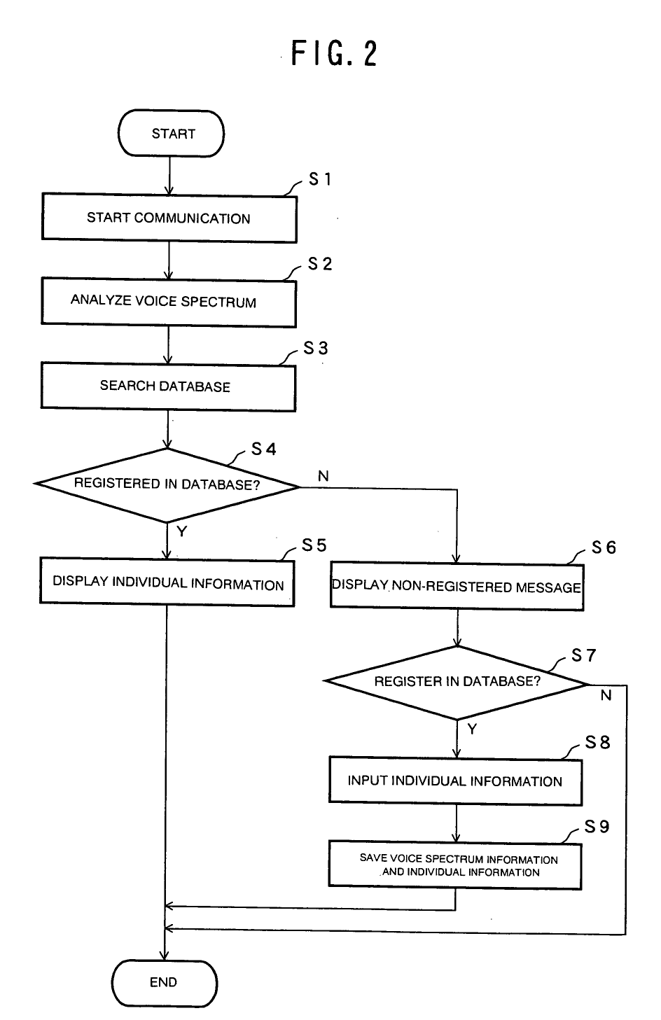

Next, an operation for identifying the caller at the start of a communication caused by an incoming call will be described with reference to the flowchart in FIG. 2. FIG. 2 is a flowchart showing one example of an operation for identifying a caller in a communications terminal relating to a first embodiment of the present invention. When a call is started by means of a caller making a call to the communications terminal 1 (S1), the MPU 7 performs a voice spectrum analysis of the voice of the caller, by means of the voice spectrum analyzing section 6 (S2), and it stores the result of this analysis in the RAM 8 as voice spectrum information for the caller.

Thereupon, the MPU 7 performs a search for the voice spectrum information of the caller, by comparing the voice spectrum information of the caller stored in the RAM 8 with the voice spectrum information in the database of the FLASH-ROM 10 (S3), and determining whether or not the voice spectrum information of the caller has been registered in the database (S4). If the voice spectrum information of the caller is registered in the database (S4, Y), then the MPU 7 reads out the individual information linked to the voice spectrum information of the caller, from the database, and displays this information on the LCD 17 (S5), whereupon the processing sequence of the communications terminal 1 is terminated.

On the other hand, if the voice spectrum information of the caller is not registered in the database (S4, N), then the MPU 7 displays a non-registered message, such as “Voice spectrum information is not registered for this caller. Register now?”, on the LCD 17 (S6). Upon seeing this non-registered message, the user makes an entry via the keypad 18 indicating whether or not to register the voice spectrum information of the caller.

If the user makes an input indicating that he or she wishes to register the information (S7, Y), then the MPU 7 accepts individual information for the caller input by means of the keypad 18 (S8), and the voice spectrum information of the caller and the individual information for the caller are mutually linked and saved to the database in the FLASH-ROM 10 (S9), whereupon the processing sequence of the communications terminal 1 terminates. If the input made by the user indicates that he or she does not wish to register the information (S7, N), then the processing sequence of the communications terminal 1 terminates.

According to the processing described above, the user is able to observe the individual information displayed on the LCD 17 at the start of a communication caused by an incoming call, and hence the user is able to identify the caller. Furthermore, if the voice spectrum information of the caller is not stored in the database in the communications terminal 1, then the user is able to input individual information relating to the caller and to save the voice spectrum information and individual information for the caller in a mutually linked fashion, in the database in the communications terminal 1.

### Second Embodiment

This embodiment is described with respect to a case where, upon receiving an incoming call at a communications terminal, the caller is identified by means of the communications terminal analyzing the voice spectrum, whereupon an external server performs a search for voice spectrum information, and the communications terminal then displays individual information.

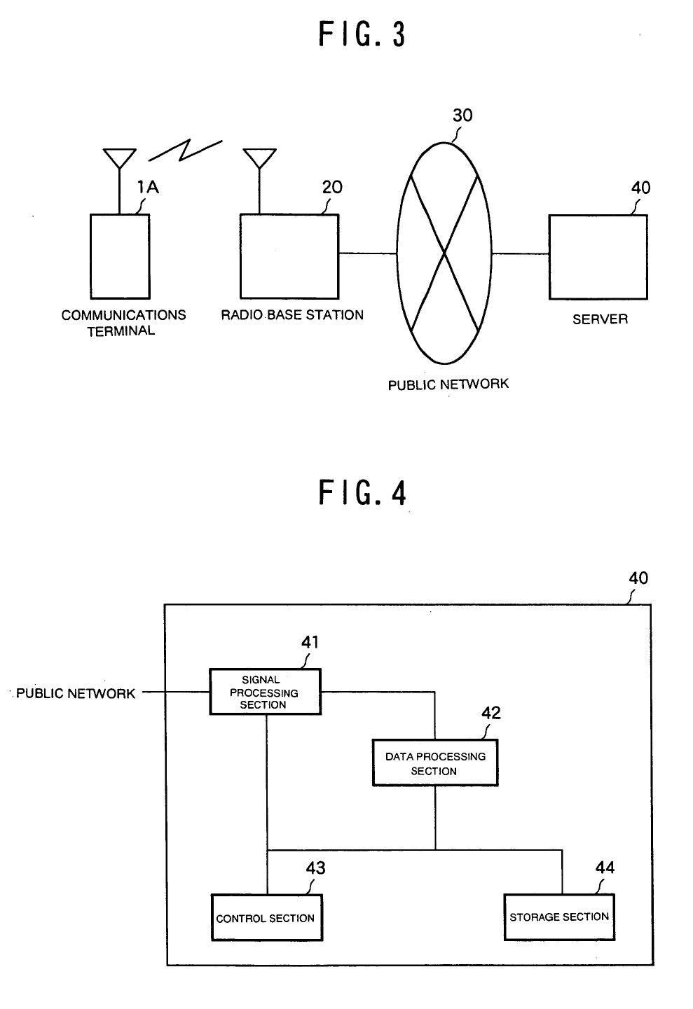

FIG. 3 is a block diagram showing one example of the composition of a communications system (individual information display system) comprising a communications terminal and a server. As shown in FIG. 3, this communications system is constituted by a communications terminal 1A, a radio base station 20, and a server 40. The communications terminal 1A and the radio base station 20 communicate with each other by radio communications, and the radio base station 20 and the server 40 communicate with each other by means of a public network (communications circuit) 30.

Firstly, the composition and operation of the communications terminal 1 A will be described. The communications terminal 1A has a similar composition to that of the communications terminal 1 in FIG. 1, but the FLASH-ROM 10 does not comprise a database. Furthermore, the. MPU 7 sends voice spectrum information output by the voice spectrum analyzing section 6 and individual information for the caller newly input via the keypad 18, from the signal processing section 3 to the server 40, and the signal processing section 3 displays individual information relating to the caller as received from the server 40, on the LCD 17.

Next, the composition and operation of the server 40 will be described. FIG. 4 is a block diagram showing one example of the composition of a server relating to a second embodiment of the present invention. The server 40 is constituted by a signal processing section 41, a data processing section 42, a control section 43 and a storage section 44. The control section 43 is connected to the signal processing section 41., the data processing section 42 and the storage section 44, and it controls these respective elements. In a transmission operation, the signal processing section 41 transmits data from the data processing section 4, to the communications terminal 1A. Furthermore, in a reception operation, the signal processing section 41 outputs data received from the communications terminal 1A, to the data processing section 42. The data processing section 42 outputs data to the storage section 44. The storage section 44 stores programs for the control section 43 and data from the data processing section 42, and the like. Furthermore, the storage section 44 stores a database which links voice spectrum information with individual information.

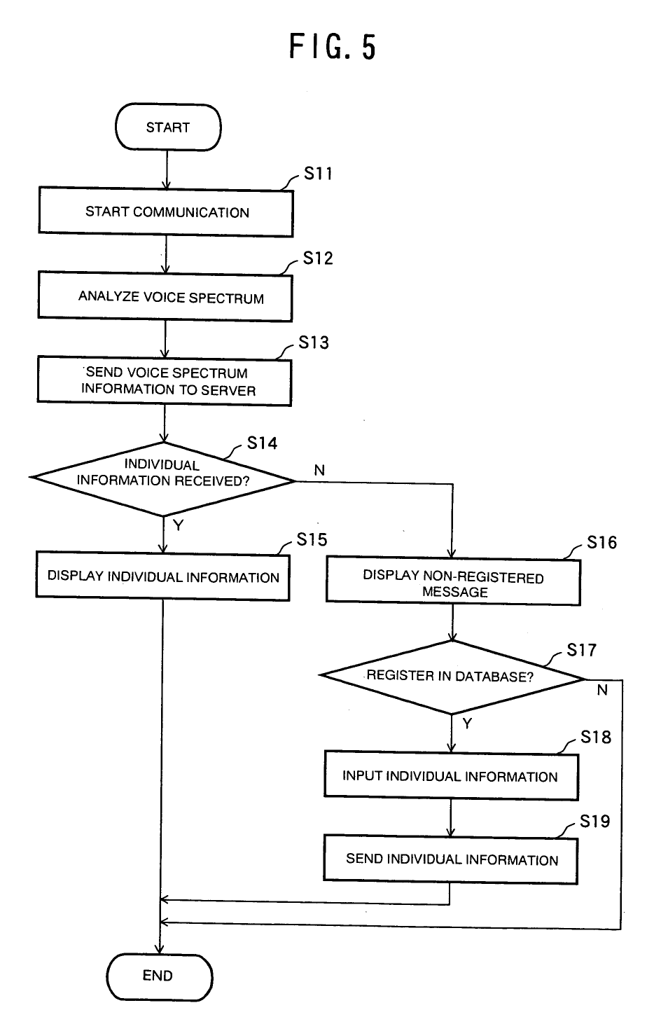

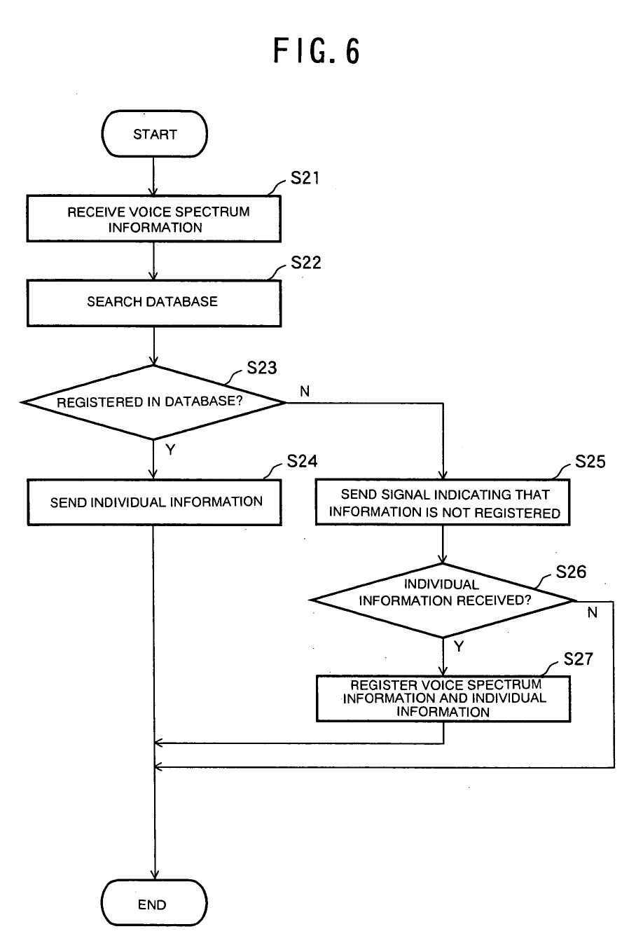

Next, an operation for identifying the caller at the start of a communication caused by an incoming call will be described with reference to the flowchart in FIG. 5 and FIG. 6. FIG. 5 is a flowchart showing one example of an operation for identifying a caller in a communications terminal relating to a second embodiment of the present invention. FIG. 6 is a flowchart showing one example of an operation for identifying a caller in a server relating to a second embodiment of the present invention.

When a call is started by means of a caller making a call to the communications terminal 1A (S11), the MPU 7 performs a voice spectrum analysis of the voice of the caller, by means of the voice spectrum analyzing section 6 (S12), and it sends the result of this analysis from the signal processing section 3 to the server 40, as voice spectrum information for the caller (S13).

In the server 40, the signal processing section 41 receives voice spectrum information for the caller from the communications terminal 1A (S21), the control section 43 searches for the voice spectrum information of the caller by comparing this voice spectrum information for the caller with the voice spectrum information contained in the database of the storage section 44 (S22), and the control section 43 judges whether or not the voice spectrum information of the caller has been registered previously (S23).

In the server 40, if the voice spectrum information of the caller is registered in the database (S23, Y), then the MPU 43 reads out the individual information linked to the voice spectrum information of the caller, from the database, and sends this information from the signal processing section 41 to the communications terminal 1A (S24), whereupon the processing sequence of the server 40 is terminated.

Next, in the communications terminal 1A, when the signal processing section 3 receives individual information from the server 40 (S14, Y), the MPU 7 displays the received individual information on the LCD 17 (S15), and the processing sequence of the communications terminal 1A is then terminated.

In the server 40, if voice spectrum information for the caller is not registered in the database (S23, N), then the control section 43 sends a signal indicating that it is not registered, from the signal processing section 41 to the communications terminal 1 A (S25).

Next, in the communications terminal 1 A, if the signal processing section 3 receives a signal from the server 40 indicating that information is not registered (S14, N), then the MPU 7 displays a non-registered message on the LCD 17 such as “Voice spectrum information is not registered for this user. Register now?” (S16). Upon seeing this non-registered message, the user makes an entry via the keypad 18 indicating whether or not to register the voice spectrum information.

Thereupon, in the communications terminal 1A, if the user makes an input indicating that he or she wishes to register the information (S17, Y), then the MPU 7 accepts individual information for the caller input by means of the keypad 18 (S18), and this individual information for the caller is sent from the signal processing section 3 to the server 40 (S19), whereupon the processing sequence of the communications terminal 1A terminates. If the input made by the user indicates that he or she does not wish to register the information (S17, N), then the procedure of the communications terminal 1A terminates.

Next, in the server 40, if the signal processing section 41 has received individual information for the caller input by the user from the communications terminal 1A (S26, Y), then the control section 43 links the voice spectrum information for the caller with the individual information for the caller and stores this linked information in the database of the storage section 44 (S27), whereupon the processing sequence of the server 40 terminates. Furthermore, if the signal processing section 41 has not received individual information for the caller input by the user, from the communications terminal 1A (S26, N), then the processing sequence of the server 40 terminates.

According to the processing described above, the user is able to observe the individual information displayed on the LCD 17 at the start of a communication caused by an incoming call, and hence the user is able to identify the caller. Furthermore, if the voice spectrum information of the caller is not stored in the database in the server 40, then the user is able to input individual information relating to the caller, transmit that information from the communications terminal 1A, and save the voice spectrum information and the individual information for the caller in a mutually linked fashion, in the database in the server 40. In the present embodiment, since a single database is provided in the server 40 and it is therefore unnecessary to provide individual databases in each communications terminal 1A, then the size of the circuitry in the communications terminal 1A can be reduced.

In the present embodiment, the communications terminal 1A does not have a database, but it is also possible to adopt a composition wherein the communications terminal 1A is also provided with a database, and the database in the server 40 is searched if the voice spectrum information of the caller is not present in the database of the communications terminal 1 A.

### Third Embodiment

This embodiment is described with respect to an example of an individual information system wherein, upon receiving an incoming call at a communications terminal, the caller is identified by means of an external server analyzing the voice spectrum and performing a search for voice spectrum information, whereupon the communications terminal displays individual information.

In the present embodiment, caller identification is performed by means of a communications terminal and a server, similarly to FIG. 3, but a communications terminal 50 is provided instead of the communications terminal 1A, and a server 60 is provided instead of the server 40.

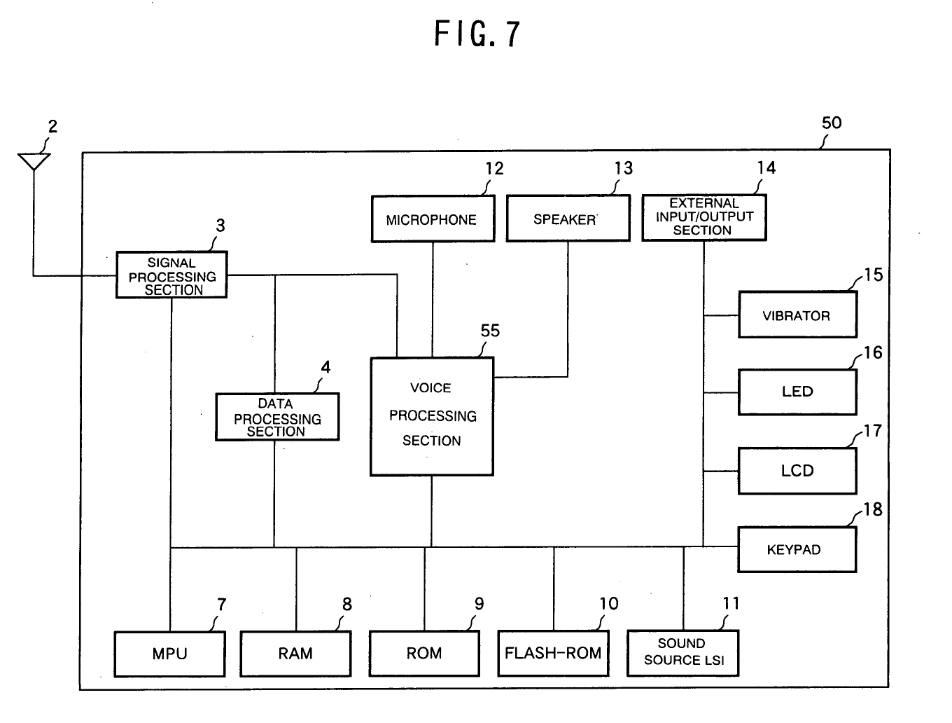

Firstly, the composition and operation of the communications terminal 50 will be described. FIG. 7 is a block diagram showing one example of the composition of a communications terminal relating to a third embodiment of the present invention. In FIG. 7, reference numerals which are the same as those in FIG. 1 indicate elements which are the same as or equivalent to elements shown in FIG. 1, and description thereof is omitted here. The communications terminal 50 according to the present embodiment does not have a voice spectrum analyzing section 6, and it comprises a voice processing section 55 instead of the voice processing section 5. The voice processing section 55 outputs voice data externally as a voice sound via the speaker 13, in addition to which it outputs the voice data required for analyzing the voice spectrum to the signal processing section 3. Furthermore, the voice processing section 55 outputs a voice received from an external source via the microphone 12, to the signal processing section 3, as voice data.

The FLASH-ROM 10 is not provided with a database. Furthermore, the MPU 7 sends voice data output by the voice processing section 55 and individual information for the caller newly input via the keypad 18, from the signal processing section 3 to the server 60, and the signal processing section 3 displays individual information relating to the caller as received from the server 60, on the LCD 17.

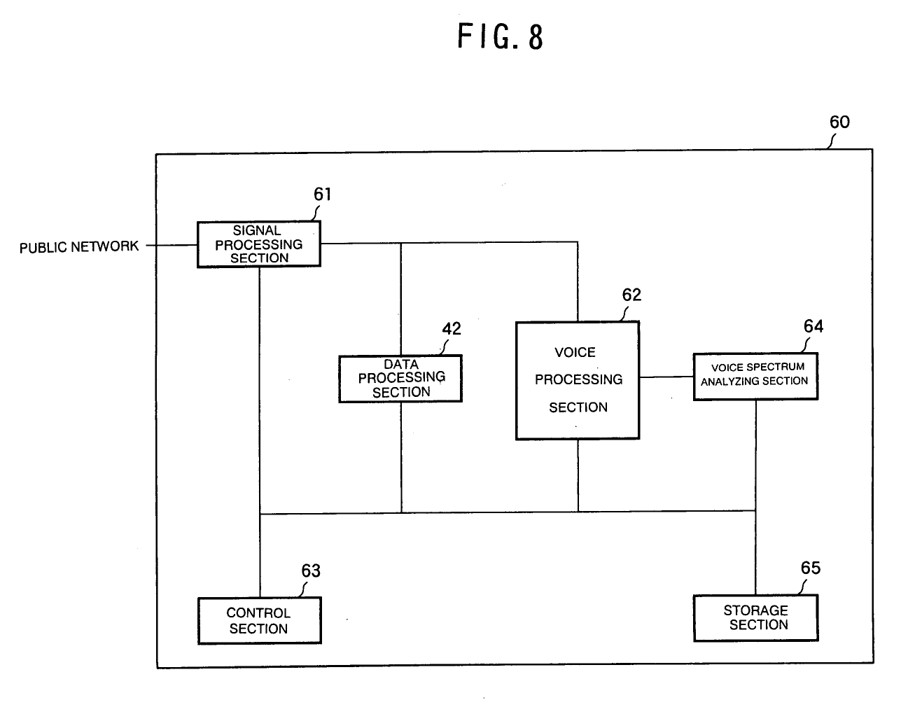

Next, the composition and operation of the server 60 will be described. FIG. 8 is a block diagram showing one example of the composition of a server relating to a third embodiment of the present invention. In FIG. 8, reference numerals which are the same as those in FIG. 1 indicate elements which are the same as or equivalent to elements shown in FIG. 1, and description thereof is omitted here. The server 60 according to the present embodiment comprises a signal processing section 61 instead of the signal processing section 41, a control section 63 instead of the control section 43, a storage section 65 instead of the storage section 44, and a voice processing section 62 and a voice spectrum analyzing section 64.

The control section 63 is connected to the signal processing section 61, the data processing section 42, the voice processing section 62, the voice spectrum analyzing section 64 and the storage section 65, and it controls these respective elements. In a transmission operation, the signal processing section 61 outputs non-voice data from the data processing section 42, to the communications terminal 50. In a reception operation, if the signal received is non-voice data, namely, data other than a voice, then the signal processing section 61 outputs the signal to the data processing section 42, and if the signal is voice data, then it outputs the signal to the voice processing section 62.

The voice processing section 62 outputs the voice data required for voice spectrum analysis, to the voice spectrum analyzing section 64. The voice spectrum analyzing section 64 calculates the voice spectrum information, similarly to the voice spectrum analyzing section 6 illustrated in FIG. 1, and outputs the spectrum to the storage section 65. The storage section 65 saves programs for the control section 63 and data from the data processing section 42, and the like. Furthermore, the storage section 65 stores a database which links voice spectrum information with individual information. Moreover, the storage section 65 temporarily stores voice spectrum information analyzed by the voice spectrum analyzing section 64.

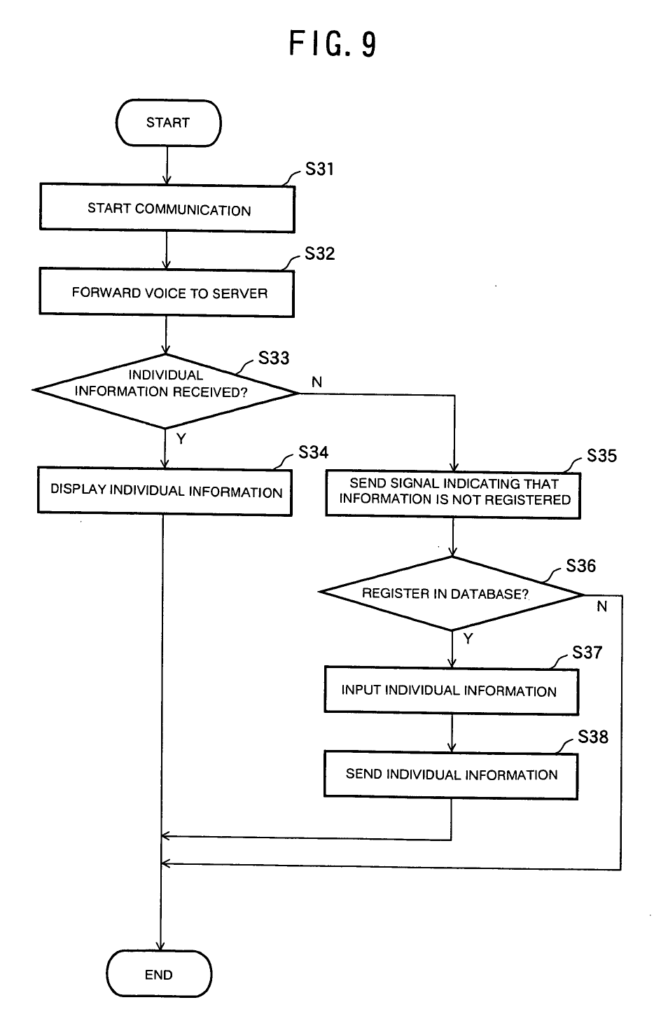

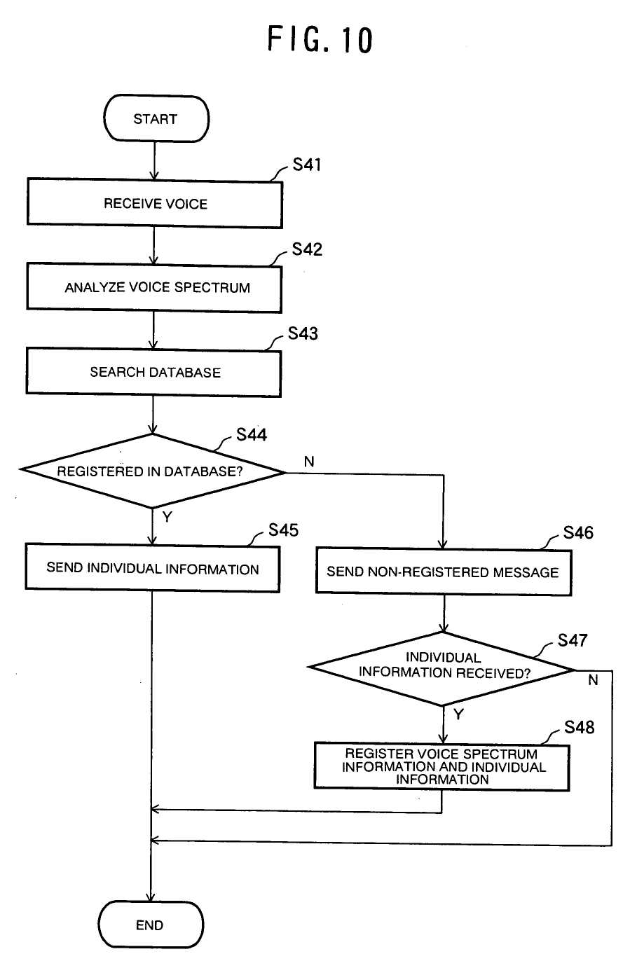

Next, an operation for identifying the caller at the start of a communication caused by an incoming call will be described with reference to the flowchart in FIG. 9 and FIG. 10. FIG. 9 is a flowchart showing one example of an operation for identifying a caller in a communications terminal relating to a third embodiment of the present invention. FIG. 10 is a flowchart showing one example of an operation for identifying a caller in a server relating to a third embodiment of the present invention.

At the communications terminal 50, if a call is started by an incoming call from a caller (S31), then the MPU 7 forwards the voice of the caller, which is required for voice spectrum analysis, from the signal processing section 3 to the server 60 (S32).

In the server 60, the signal processing section 61 receives the voice forwarded by the communications terminal 50 (S41), and the control section 63 carries out voice spectrum analysis of the voice of the caller, by means of the voice spectrum analyzing section 64 (S42), searches for the voice spectrum information of the caller by comparing the voice spectrum information for the caller obtained by the voice spectrum analysis with the voice spectrum information contained in the database of the storage section 65 (S43), and judges whether or not the voice spectrum information of the caller has been registered previously in the database (S44).

In the server 60, if the voice spectrum information of the caller is registered in the database (S44, Y), then the control section 63 reads out the individual information linked to the voice spectrum information of the caller, from the database, and sends this information from the signal processing section 61 to the communications terminal 50 (S45), whereupon the processing sequence of the server 60 terminates.

Next, in the communications terminal 50, when the signal processing section 3 receives individual information from the server 60 (S33, Y), the received individual information is displayed on the LCD 17 (S34), and the procedure of the communications terminal 50 is then terminated.

In the server 60, if voice spectrum information for the caller is not registered in the database (S44, N), then the control section 63 sends a signal indicating that it is not registered, from the signal processing section 61 to the communications terminal 50 (S46).

Next, in the communications terminal 50, if the signal processing section 3 receives a signal from the server 60 indicating that information is not registered (S33, N), then the MPU 7 displays a non-registered message on the LCD 17 such as “Voice spectrum information is not registered for this user. Register now?” (S35). Upon seeing this non-registered message, the user makes an entry via the keypad 18 indicating whether or not to register the voice spectrum information.

Next, in the communications terminal 50, if the user makes an input indicating that he or she wishes to register the information (S36, Y), then the MPU 7 accepts individual information for the caller input by means of the keypad 18 (S37), and this individual information for the caller is sent from the signal processing section 3 to the server 60 (S38), whereupon the processing sequence of the communications terminal 50 terminates. If the input made by the user indicates that he or she does not wish to register the information (S36, N), then the processing sequence of the communications terminal 50 terminates.

Next, in the server 60, if the signal processing section 61 has received individual information for the caller input by the user from the communications terminal 50 (S47, Y), then the control section 63 links the voice spectrum information for the caller with the individual information for the caller and stores this linked information in the database of the storage section 65 (S48), whereupon the processing sequence of the server 60 terminates. Furthermore, if the signal processing section 61 has not received individual information for the caller input by the user, from the communications terminal 50 (S47, N), then the processing sequence of the server 60 terminates.

According to the processing described above, the user is able to observe the individual information displayed on the LCD 17 at the start of a communication caused by an incoming call, and hence the user is able to identify the caller. Furthermore, if the voice spectrum information of the caller is not stored in the database in the server 60, then the user is able to input individual information relating to the caller, transmit that information from the communications terminal 50, and save the voice spectrum information and the individual information for the caller in a mutually linked fashion, in the database in the server 60. In the present embodiment, by carrying out voice spectrum analysis and comparison in a server 60 having a higher computing capacity than the communications terminal 50, it is possible to identify an individual person rapidly, and furthermore, since it is unnecessary to provide a voice spectrum analyzing section and a database individually in the communications terminal 50, then the size of the circuitry in the communications terminal 50 can be reduced.

The first to third embodiments were described with reference to a communications terminal which performs radio communications, but it is also possible to apply the present invention to a communications terminal which performs wired communications. Moreover, a visual display using an LCD was described as the display section, but it is also possible to provide a voice indication, or the like. First to third embodiments were described above, but the composition and operation of the communications terminal and server described in the foregoing embodiments are only examples for the purpose of realizing the present invention, and the composition is not limited in particular and may be adapted suitably, provided that it does not deviate from the essence of the present invention.

### INDUSTRIAL APPLICABILITY

According to the present invention as described above, at the start of a communication caused by an incoming call, it is possible for the user to identify an individual caller accurately, by observing the individual information of the caller displayed on the screen, and hence it is possible, for example, to avoid situations where confusion is caused to the called party due to incorrect identification of the caller.

1. A communications terminal comprising:
a database that stores individual information for an individual person and voice spectrum information for said individual, in an associated manner;
a voice spectrum analyzing section that extracts voice spectrum information for said caller from the voice of the caller, at the start of a communication caused by an incoming call;
a calculating section that identifies individual information in said database relating to said caller, by comparing the voice spectrum information for said caller with voice spectrum information in said database; and
a display section that displays individual information for said caller thus 11 identified.

2. The communications terminal according to claim 1, comprising:
an input section that inputs individual information for said caller;
wherein a set comprising voice spectrum information for said caller and individual information for said caller obtained from said input section can be registered in said database.

3. A voice spectrum information search server capable of being connected to a communications terminal by means of a communications circuit, comprising:
a database that stores individual information for an individual person and voice spectrum information for said individual, in an associated manner;
a reception section that receives information including voice spectrum information from said communications terminal;
a calculating section that identifies individual information in said database, by comparing voice spectrum information received by said reception section with voice spectrum information in said database; and
a transmission section that transmits the individual information in said database thus identified, to said communications terminal.

4. A communications terminal capable of being connected to the voice spectrum information search server according to claim 3, by means of a communications circuit, comprising:
a voice spectrum analyzing section that extracts voice spectrum information for said caller from the voice of the caller, at the start of a communication caused by an incoming call;
a transmission section that transmits said voice spectrum information for said caller to said voice spectrum information search server;
a reception section that receives individual information for said caller from said voice spectrum information search server; and
a display section that displays the individual information for said caller obtained by said reception section.

5. The communications terminal according to claim 4, comprising:
an input section that inputs individual information for said caller;
wherein a set comprising voice spectrum information for said caller and individual information for said caller obtained from said input section can be registered in the database of said voice spectrum information search server.

6. An individual information display system comprising the voice spectrum information search server according to claim 3, and the communications terminal according to claim 4.

7. A voice spectrum information search server capable of being connected to a communications terminal by means of a communications circuit, comprising:
a database that stores individual information for an individual person and voice spectrum information for said individual, in an associated manner;
a reception section that receives information including a voice from a communications terminal;
a voice spectrum analyzing section that extracts voice spectrum information from the voice received by said reception section;
a calculating section that identifies individual information in said database, by comparing voice spectrum information extracted by said voice spectrum analyzing section with voice spectrum information in said database; and
a transmission section that transmits the individual information in said database thus identified, to said communications terminal.

8. A communications terminal capable of being connected to the voice spectrum information search server according to claim 7, by means of a communications circuit, comprising:
a transmission section for transferring the voice of a caller to said voice spectrum information search server, at the start of a communication caused by an incoming call;
a reception section that receives individual information for said caller from said voice spectrum information search server; and
a display section that displays the individual information for said caller obtained by said reception section.

9. The communications terminal according to claim 8, comprising:
an input section that inputs individual information for said caller;
wherein a set comprising voice spectrum information for said caller and individual information for said caller obtained from said input section can be registered in the database of said voice spectrum information search server.

10. An individual information display system comprising the voice spectrum information search server according to claim 7, and the communications terminal according to claim 8.

11. An individual information display method in a communications terminal that displays individual information for a caller at the start of a communication caused by an incoming call, comprising the steps of:
storing individual information for an individual person and voice spectrum information for said individual, in an associated manner, in a database;
extracting voice spectrum information for said caller from the voice of said caller;
identifying individual information in said database relating to said caller, by comparing the voice spectrum information for said caller with voice spectrum information in said database; and
displaying individual information for said caller thus identified.

12. An individual information display program stored on a computer-readable medium in order to cause a computer to execute display of individual information for a caller at the start of a communication caused by an incoming call, wherein said program causes a computer to execute the steps of:
storing individual information for an individual person and voice spectrum information for said individual, in an associated manner, in a database;
extracting voice spectrum information for said caller from the voice of said caller;
identifying individual information in said database relating to said caller, by comparing the voice spectrum information for said caller with voice spectrum information in said database; and
displaying individual information for said caller thus identified.
